(19) United States
(12) Patent Application Publication
(10) Pub. No.: US 2005/0210693 A1
(43) Pub. Date: Sep. 29, 2005

(54) Roofing information indicating device

(76) Inventors: John William Collins, Cardiff (GB); John Raymond Collins, Cardiff (GB)

Correspondence Address: KING & SCHICKLI, PLLC, 247 NORTH BROADWAY, LEXINGTON, KY, 40507, US

(21) Appl. No.: 10/511,357

(22) PCT Filed: Apr. 14, 2003
(86) PCT No.: PCT/GB03/01558

§ 371 Date: Oct. 12, 2004

(30) Foreign Application Priority Data
Apr. 13, 2002 (GB) 0208541.3

(51) Int. Cl. B43L 7/10

(52) U.S. Cl. 33/471

(57) ABSTRACT

A device for providing an indication of roofing related information. The device includes a first component (1) including a first set (4) of roofing related information, and at least one further set (9) of roofing related information. The positions of the information sets have a predetermined relationship to one another on the first component. The device also includes a second component (2) pivotally connected for relative rotary movement to the first component. The second component has a first information display position (6) for indicating a selected member of the first information set and at least one further information display position (10) for indicating the related member of the at least one further information set.

The present invention relates to a device for providing an indication of roofing related information.

It is of great importance that the components used for constructing a roof have correct dimensions, otherwise the consequences can be expensive and dangerous. As calculating the dimensions is quite complex, it is common for builders to use reference books or trial and error. There are also some tools available, but these require skill and training to use. Each page of such reference books contain tables showing the correct dimensions for various types of bevels of rafters and the like for a roof of a given pitch. Unfortunately, due to the amount of data contained in such books, obtaining the information can be a time consuming process and the data needed may be spread over more than one page. This method is prone to human error if information collected from several pages is written down incorrectly.

Embodiments of the present invention aim to provide a device that allows several pieces of roofing related information to be obtained quickly and easily.

According to the present invention there is provided a device for providing an indication of roofing related information, the device including:
a first component including:
   a first set of roofing related information, and
   at least one further set of roofing related information,
   the positions of the information sets having a predetermined relationship to one another on the first component, and
a second component pivotally connected for relative rotary movement to the first component, the second component having a first information display position for indicating a selected member of the first information set and at least one further information display position for indicating the related member of the at least one further information set.

All or some of the information display positions may be located at or near an edge of the second component. Thus, the desired information can be viewed by rotating the first component relative to the second such that a member of the first information set is substantially aligned with the edge acting as the first information display position, with the related member(s) of the at least one further information set(s) being substantially aligned with the edge(s) acting as the further information display position(s). Alternatively or additionally, the information display positions may include one or more apertures forming windows in the second component so that the members of the information sets can be viewed through the windows. One or more of the information display positions may be labelled. Illustrations relating to the information displayed may also be provided on the device. The information display positions and/or the members of the different information sets may be set out in a way intended to help distinguish between them. For example, the set members may be printed on or in different colours.

The first and second components may be substantially arc-shaped segments, which are typically substantially flat. In this case, the members of the information sets on the first component can be arranged in arcs located at intervals along the radial distance of the first component, with the corresponding information display positions being arranged at corresponding intervals along the radial distance of the second component.

In one embodiment, information sets are included on two opposite sides of the first component. Suitably, the second component can be formed of two parts at least partially spaced apart, such that the first component can fit and rotate between the two parts. The size of the first component may be marginally smaller (e.g. up to around 5 mm) to allow it to fit within an envelope or sleeve defined by the two parts of the second component to facilitate this.

Information display positions corresponding to the information sets included on a first side of the first component may be provided on one of the parts of the second component. Information display positions for the information sets included on the opposite side of the first component may be provided on the other part of the second component.

One embodiment of the device further includes a third component pivotally connected to the first or second component at a second axis for relative rotary movement, the third component including at least one information set. The third component may be substantially circular or arc-shaped. The display positions for the information set(s) of the third component may be in the form of at least one window in the first or second component.

An edge of the first component may include one or more foldable portions for facilitating alignment with the edge of a workpiece.

The information sets can include data relating to some or all of the following: the pitch of the roof; the length of a rafter (per metre run); the length of a hip rafter (per metre run); the plumb cut for common and/or jack rafters; the edge cut to purlin; the side cut of purlin; the hip or valley plumb cut; the common rafter plumb cuts; the jack rafter edge cut; the bottom edge jack against lay board angle; the top edge cut of a hip rafter; the seat cut hip or valley; the seat cut common (and/or jack) rafter; the bottom edge jack against a lay board; the top edge cut of a hip rafter; the valley jack edge cut angle to be used between an existing/main roof and a new/adjoining roof.

The device may include representations of roof constructions, typically printed on the second component. Directions for using the device may be included on the device. The device may be formed of paper, card, plastic and/or metal materials.

Whilst the invention has been described above, it extends to any inventive combination of the features set out above or in the following description.

The invention may be performed in various ways, and, by way of example only, an embodiment thereof will now be described, reference being made to the accompanying drawings, in which:—

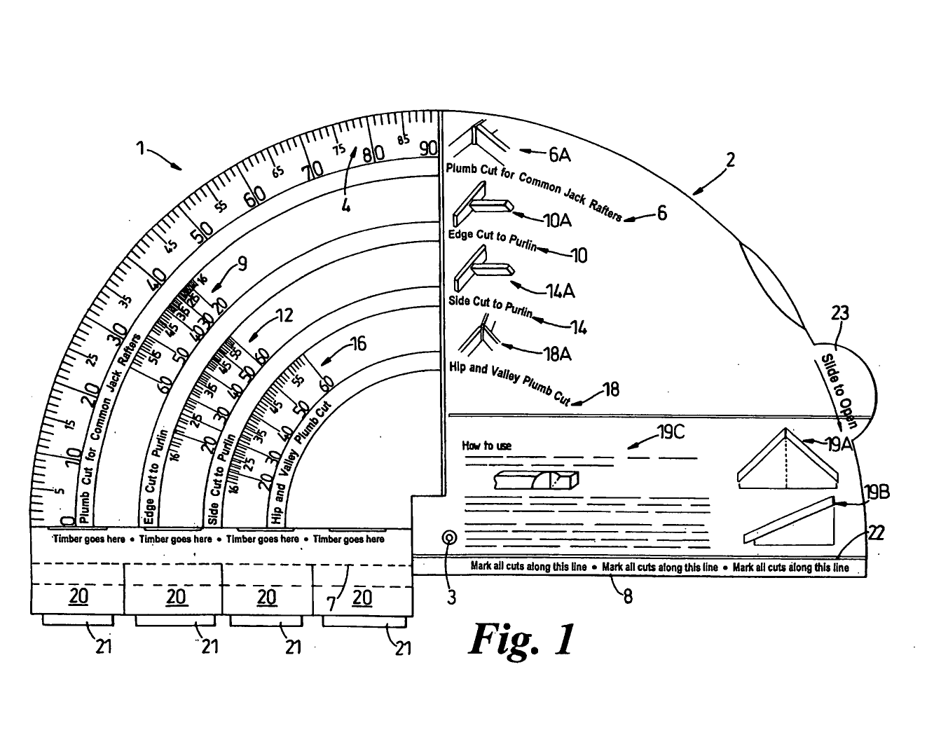

FIG. 1 is a view of the first sides the first and second components of the device with the second component fully extended for ease of description;

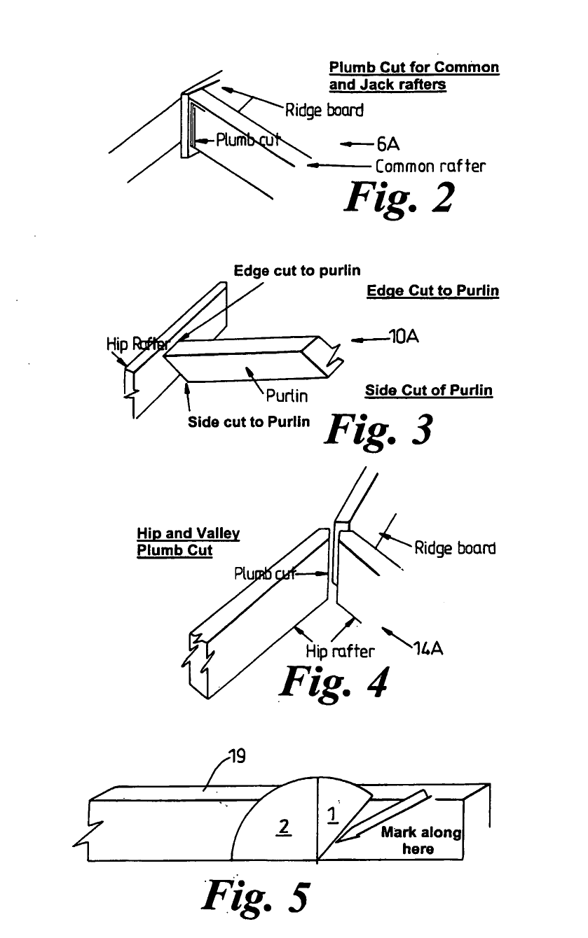

FIGS. 2 to 4 detail representations of roofing timbers and cuts printed on the first side of the second component;

FIG. 5 is a schematic diagram showing the device in use with a workpiece;

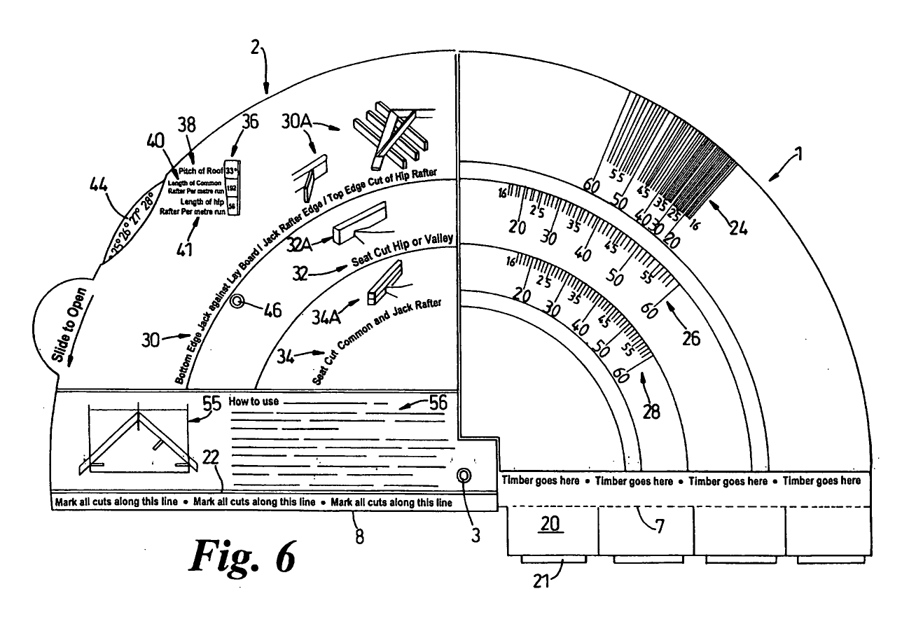

FIG. 6 is a view of the opposite side of the first and second components, again with the second component fully extended and showing a window for viewing an information set on a third component;

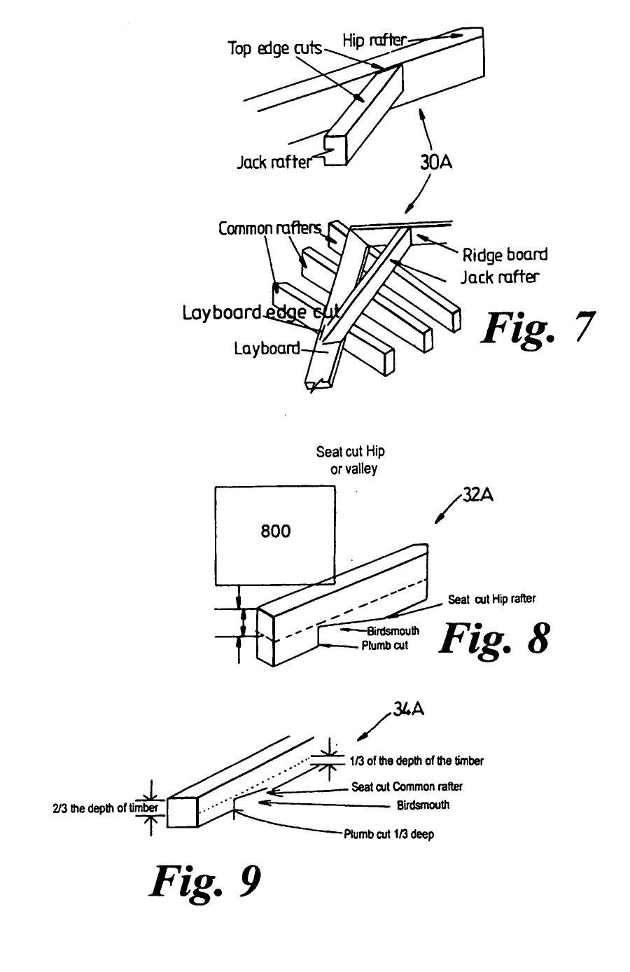

FIGS. 7 to 9 detail representations of roofing timbers and cuts printed on the second side of the second component;

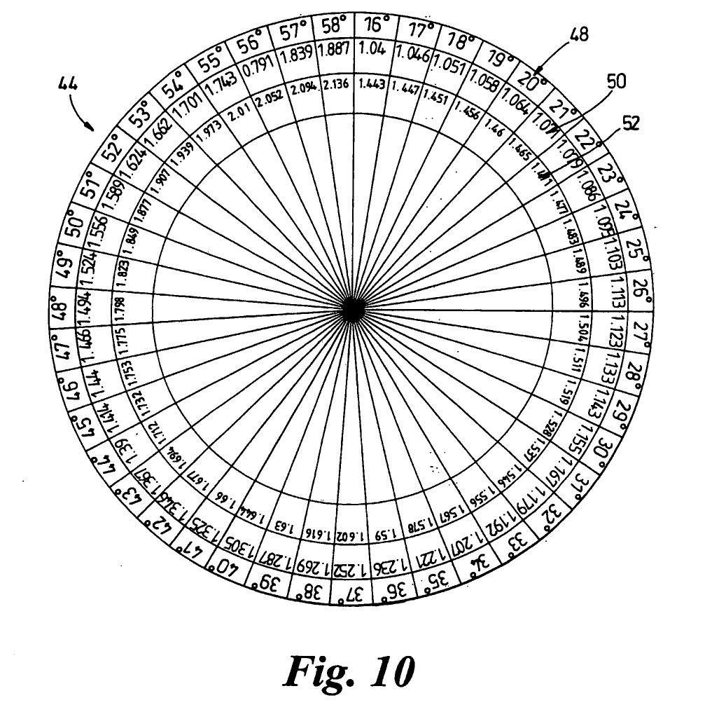

FIG. 10 is a view of the third component;

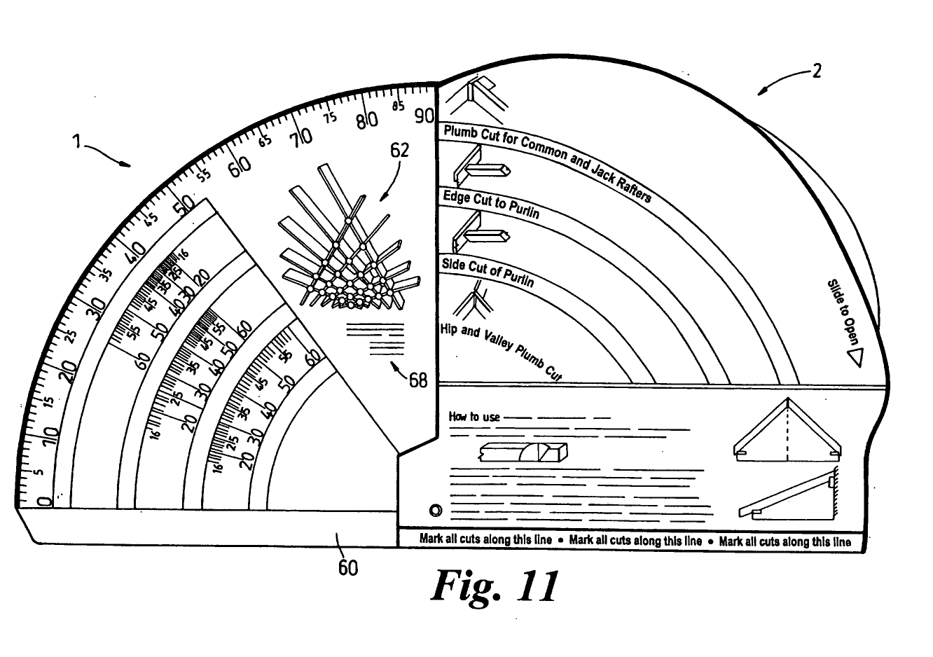

FIG. 11 is a view of the first sides the first and second components of a second embodiment of the indicating device, and

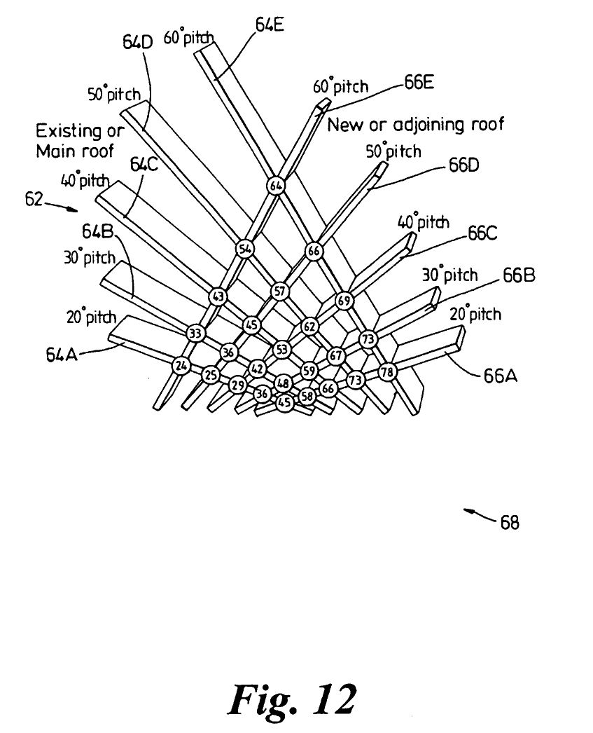

FIG. 12 details a reference diagram printed on one of the components of FIG. 11.

Referring to FIG. 1, a first embodiment of the indicating device comprises a first substantially arc-shaped segment 1 of card having a radius of around 215 mm and an arc angle of approximately 90°. It will be appreciated that materials other than card can be used to construct the device, e.g. plastic, metal or wood. In fact, the improved durability of such materials may be desirable. In some embodiments, the information may not be printed directly onto the components, for example, an adhesive veneer containing the information may be stuck onto a plastic component. It will be understood that any of the device dimensions given herein are examples only and wide variations are possible according to the nature of the device and workpiece. The device further includes a second segment 2 comprising two sheets of card, having dimensions substantially identical to the first.

A common pivot 3 allows the two segments 1, 2 to rotate relative to each other with the single sheet first component sandwiched between the two cards of the second component. The pivot 3 can be a pin, eyelet or the like. The second segment 2 is shaped such that a square-shaped protrusion is located at its corner near the pivot 3 to limit the rotation of the first segment 1.

Arranged along the perimeter of the arc of the first side of the first segment 1 is a printed information set in the form of an indicia 4 representing angles between 0 and 90°. The indicia 4 is printed on an arc-shaped band of a first colour, e.g. purple, that extends to around 22 mm (in this example) along the radial distance from the edge of the arc. A label “Plumb Cut for Common and Jack Rafters” is printed at the bottom of the coloured band. At a generally corresponding radial distance (around 25 mm in the example) near one edge (chord) of the second segment 2 a label 6 “Common Rafter Plumb Cut” is printed. An illustration 6A (detailed in FIG. 2) provides a representation of the cut.

The edge of the segment 2 adjacent the label 6 is intended to be used as an information display position. That is, when the device is being used a user rotates the segments relative to each other so that a line of the indicia 4 corresponding to the required pitch angle of the roof being constructed is substantially aligned with the information display position, so that the angle formed between a datum line 7 defined by the extended edge of the first segment and the datum line 8 defined on the second segment 2 represents the Common Rafter Plumb Cut angle.

The first segment 1 further includes a second indicia 9 representing angles between 16 and 60°. The indicia 9 are printed along an arc having a radial distance of between 24 mm and 47 mm on the first segment 1. Similarly to the first indicia 4, the second indicia 9 is printed on a coloured band (preferably of a different colour, e.g. orange) which includes a label “Edge Cut to Purlin” at its base. It will be understood that the other indicia on (both sides of) the first segment 1 can be printed on coloured bands and can have labels arranged in a similar manner. The colours of adjacent bands preferably contrast with each other. A corresponding label 10 is printed at a generally corresponding radial distance near the edge of the second segment 2. An illustration 10A (detailed in FIG. 3) provides a representation of the cut.

The indicia 9 are aligned so that, when the appropriate pitch angle from the indicia is aligned with the edge defining the information display position, the angle defined between the datum lines 7 and 8 is the required angle for the jack rafter edge cut for a roof of that pitch angle.

A third set of indicia 12 representing angles 16 to 600 is printed along a coloured arc-shaped band having a radial distance of between 61 mm and 85 mm on the first segment 1. A corresponding label 14 “Side Cut of Purlin” is printed at a generally corresponding radial distance near the edge of the second segment 2. An illustration 14A (detailed in FIG. 4) provides a representation of the cut. A fourth set of indicia 16 is printed in a coloured arc-shaped band having a radial distance of between 91 mm and 116 mm on the first segment 1. A label 18 “Hip and Valley Plumb Cut” is printed at a generally corresponding radial distance near the edge of the second segment 2.

To determine the appropriate angle for a given cut, the user notes the label 6, 10, 14, 18 identifying that cut and then pivots the device to align the indicia identifying the pitch angle of the roof (measured previously) with the information display position (i.e. edge) adjacent the label. The datum lines 7 and 8 then define between them the particular angle of cut which can then be marked on the rafter or the workpiece being cut. FIG. 5 shows the device in use with a workpiece 19.

The segment 2 also includes two representations 19A, 19B of parts of a roof construction. The first one 19A shows the roof pitch and run, a wall plate, the ridge and the common rafter. The second representation 19B shows the common rafter and the run for a lean-to roof.

Directions 19C for using the indicating device are also printed on the second side of the segment 2. The directions 19C can include an illustration of the device in use (similar to FIG. 5) and may read as follows:
“ . . . . For example, if you need to cut a roof with a 30° pitch, place the device against the timber as illustrated in FIGURE.
To mark the plumb cut on a common rafter, slide the device open until the coloured band marked Plumb Cut for Common and Jack Rafters reads 30. This then gives you the plumb cut for a common rafter on a roof at a 30° pitch. Simply mark the timber along the line indicated ‘mark all cuts here’.
To mark the seat cut on a common rafter, simply follow the instructions above except this time, open the device until the number 30 is alongside the coloured band marked Seat Cut Common Rafter (this gives the seat cut for a common rafter on a roof with a 30° pitch). Again mark the timber along the indicated edge. Follow these steps for all other cuts required . . . ”To assist alignment of this device, the first segment 1 preferably has one or more foldable flap attached to the datum line 7 and foldable about that line. In the embodiment illustrated, there are four separate flaps 20. In use the user may fold one or more of the flaps 20 over the edge of the workpiece to help ensure that datum line 3 is accurately aligned therewith. The flaps have tabs 21 that fit into corresponding slots 22 in the segment 1. The angle of the cut may then be marked on the workpiece by running a pencil or scribe along the datum edge 8 once the appropriate pitch angle has been dialled in. The datum edge 8 is marked (on both sides) “Mark All Cut Along this Line” and the datum edge 3 is marked (on both sides) “Timber Goes Here” for ease of use.

It will be appreciated also that it is possible to use this device to mark up compound cuts on rafters, that is ones where the cutting plane is not perpendicular to any of the surfaces of the workpiece. Having more than one separate flap 20 allows them to be folded onto different faces of the workpiece, thereby making the marking of compound cuts easier.

A semi-circular tab 23 (marked on both sides with “Slide to Open”) protrudes from the edge of the second segment 2 to make rotation of the two segments easier.

Referring to FIG. 6, in a similar manner, there are further sets of indicia 24, 26 and 28 printed on the second side of the first segment 1. Corresponding labels 30 (“Bottom Edge Jack against Lay Board; Jack Rafter Edge; Top Edge Cut of Hip Rafter”), 32 (“Seat Cut Hip or Valley”) and 34 (Seat Cut Common and Jack Rafter”) and corresponding illustrations 30A, 32A and 34A (detailed in FIGS. 7, 8 and 9, respectively) are printed on the second side of the second segment 2. These further indicia and labels allow the angles indicated by the labels to be determined, with the resultant angle being defined between the datum lines 7 and 8 as previously described.

The second side of the segment 2 further includes a window 36. Adjacent the sides of the window 36, three labels 38, 40, 42 are printed. Each of the labels corresponds to a field of four sets of information printed on a disc-shaped card 44, which is illustrated in FIG. 10.

The centre of the disc 44 is attached to the piece of card forming the second side of the segment 2 by means of a pivot 46. The pivot 46 and window 36 are located on the second segment 2 such that a part of the circumference of the disc 44 protrudes beyond the outer arc edge of the segment 2. The user uses the protruding part to rotate the disc 44. A notch is cut into part of the arc edge of the segment 2 to help a user grip the disc 44.

The disc 44 is divided in the example into 42 equal segments, each of which contains information relating to a roof having a pitch of between 16 and 58°. In an alternative embodiment, information for roofs having pitches of 16 to 60° is included on the disc. The values of the pitch angles are printed as indicia 48 arranged around the circumference of the disc.

Second and third sets of indicia 50, 52 are printed concentrically and indicia is printed inwardly of the others. The rings of the three indicia are of different colour to help distinguish between them.

The values of the two indicia 50, 52 printed in one segment of the disc give the correct values of specific dimensions (mentioned below) for a roof pitch of an angle represented by the indicia 48 appearing in the same segment.

In use, the roof pitch angle is selected by rotating the disc 44 so that the segment containing desired angle is shown in the window 36. The selected angle of the indicia 48 is substantially aligned with the label 38 (“Pitch of Roof”). The labels 40 (“Length of Rafter Per metre run”) and 42 (“Length of Hip Rafter Per meter run”) are printed adjacent the window 36 at positions generally corresponding to where the values of the two indicia 50, 52, respectively, of the segment can be viewed.

Also printed on the second side of the second segment 2 is a representation 55 of parts of a roof construction that can act as an aid for working out what information is needed. The representation 55 shows a common rafter, the full span of the roof, a purlin, the pitch of the roof, the run of the rafter, the ridge board and the overhang. Directions 56 for using the indicating device can also be printed on the second side of the segment 2. These may read as follows:
“To calculate the length of your common rafter gently turn the wheel to the required pitch of the roof (in the top band of the wheel) and multiply the given length per metre run by the run of the rafter . . .
For example, suppose you are cutting a roof with a 30° pitch and the run of the rafter was 4 m, multiply 4 by 1.155 (the middle band on the wheel next to Length of the Rafter). This will give you the true length of the common rafter. Add on the overhang of the soffit as required.
To find the true length of the hip rafter, follow the steps above, this time without deducting half the thickness of the ridge as hip rafters fit against each other at the ridge.
Note: the run of rafter is measured horizontally as shown, and not along the length of the rafter.”

The layout and spacing of the indicia representing the roof pitch may be determined empirically, by calculation or by looking up in a reference book and then setting the datum lines to the appropriate cut angle and marking the corresponding roof pitch angle on the first segment, and repeating this for reach of the roof pitch angles likely to be of interest. This exercise can be repeated for all the cut angles which the device is required to provide.

Turning to FIG. 11, one side of an alternative embodiment of the device is shown. Many of the elements are substantially identical to the embodiment described above and so need not be described in detail again. One difference in the second embodiment is that there is a protrusion 60 attached to and extending along the length of the base edge of the segment 1. The protrusion 60 has a greater thickness than the segment and a similar protrusion is also preferably present on the opposite side of the segment. The protrusion 60 is intended to limit the rotational movement of the second segment 2. The second segment 2 does not have a regular arc shaped outline. It will be appreciated that the second sides of the components of FIG. 11 can be configured in a similar manner as shown in FIG. 6.

Another difference between the second embodiment and the first is the presence of a reference diagram 62 that is printed on a part of the segment 1 that is substantially blank in the first embodiment. The reference diagram 62 is shown in detail in FIG. 12.

The diagram 62 is intended to help a user calculate the approximate angles of the valley jack edge cut should the pitch of the adjoining roof differ from that of the main roof. The diagram includes a five-by-five grid of intersecting transverse lines. It will be appreciated that the grid in the diagram has been stylised to give a “perspective” effect. A first set of five numbers representing the possible angle (e.g. 20°, 30°, 40°, 50° or 60°) of the existing/main roof is given adjacent the ends of a first set of five respective grid lines (labelled 64A-E). A corresponding second set of numbers representing the angles of the new/adjoining roof is given adjacent the ends of a second set of five respective grid lines (labelled 66A-E and transverse to the lines of the first set). Circled numbers located at points where the vertical and horizontal lines intersect. The circled numbers represent the desired valley jack edge cut angles for an existing/main roof and a new/adjoining roof having pitch angles corresponding to those given at the ends of the sets of grid lines. For example, the approximate valley jack edge cut angle for a 60° pitch existing/main roof and a 30° pitch new/adjoining roof is given as 73°. Instructions 68 for using the diagram 62 are printed adjacent the diagram.

It will be appreciated that further modifications can be made to the embodiments described above. First, the range of any or all of the indicia/information on the device can be changed. For example, the roof pitch angles and corresponding indicia on the disc 44 may be expanded to a range of 0° to 90° instead of 16 to 60°. Also, the units used for the information may be modified, e.g. in the US roof pitches are often expressed in terms of “rise per foot/metre” rather than angles.

Notes on Figures

Text printed at 800 in FIG. 8:
⅔ the depth of the common rafter, to ensure that the top of the hip remains flush with the tops of the rafters

Text printed at 68 in FIG. 12:
This table gives the approximate angles of the Valley Jack Edge Cut should the pitch of the adjoining roof differ from that of the main roof.
E.g. Existing or Main roof pitch (on the left of the table) 40° adjoining or New roof pitch (on the right of the table) 30°
Where they cross on the table 590

1. A device for providing an indication of roofing related information, the device including:
a first component (1) including:
a first set (4) of roofing related information, and
at least one further set (9) of roofing relating information,
the positions of the information sets having a predetermined relationship to one another on the first component, and
a second component (2) pivotally connected for relative rotary movement to the first component, the second component having a first information display position (6) for indicating a selected member of the first information set and at least one further information display position (10) for indicating the related member of the at least one further information set.

2. A device according to claim 1, wherein all or some of the information display positions (6,10) are located at or near an edge of the second component (2).

3. A device according to claim 1, wherein the information display positions include one or more apertures (36) forming one or more respective windows in the second component (2) so that the members of one or more of the information sets (48) are viewable through the windows.

4. A device according to claim 1, wherein one or more of the information display positions (6) are labelled (6A).

5. A device according to claim 1, wherein the information display positions (6, 10) and/or the members of the different information sets (4, 9) are set out in a way intended to distinguish between them.

6. A device according to claim 5, wherein the information set (4, 9) members are printed on or in different colours.

7. A device according to claim 1, wherein the first (1) and second (2) components are substantially arc-shaped segments.

8. A device according to claim 7, wherein the members of the information sets (4, 9) on the first component (1) are arranged in arcs located at intervals along the radial distance of the first component, and the corresponding information display positions (6, 10) being arranged at corresponding intervals along the radial distance of the second component (2).

9. A device according to claim 1, wherein the information sets (4, 24) are included on two opposite sides of the first component (1).

10. A device according to claim 9, wherein the second component (2) is formed fo two parts at least partially spaced apart, such that the first component (1) can fit and rotate between the two parts.

11. A device according to claim 9, wherein the information display positions (6, 10) corresponding to the information sets (4, 9) included on a first side of the first component (1) are provided on one of the parts of the second component (2) and the information display positions (30,32) for the information sets (24,26) included on the opposite side of the first component are provided on the other part of the second component.

12. A device according to claim 1, further including a third component (44) pivotally connected to the first or second component (2) at a second axis (46) for relative rotary movement, the third component including at least one information set (48).

13. A device according to claim 12, wherein the third component (44) is substantially circular.

14. A device according to claim 12, wherein the display position for the information set of the third component (44) is in the form of a window (36) in the first or second component (2).

15. A device according to claim 1, wherein an edge of the first component (1) includes one or more foldable portions (7) for facilitating alignment of the device with an edge of a workpiece.

16. A device according to claim 1, wherein the information sets include data relating to some or all of the following: the pitch of the roof; the length of a rafter (per metre run); the length of a hip rafter (per metre run); the plumb cut for common and/or jack rafters; the edge cut to purlin; the side cut of purlin; the hip or valley plumb cut; the common rafter plumb cuts; the jack rafter edge cut; the bottom edge jack against lay board angle; the top edge cut of a hip rafter; the seat cut hip or valley; the seat cut common (and/or jack) rafter; the bottom edge jack against a lay board; the top edge cut of a hip rafter; the valley jack edge cut angle to be used between an existing/main roof and a new/adjoining roof.

17. A device according to claim 1, further including representations (6A, 10A, 14A, 18A) of roof constructions.

18. A device according to claim 1, further including directions (19C) for using the device.

19. A device according to claim 1, wherein the device is formed of paper, card, plastic and/or metal materials.
